(19) United States
(12) Patent Application Publication
(10) Pub. No.: US 2026/0061851 A1
(43) Pub. Date: Mar. 5, 2026

(54) SLIP DETERMINATION APPARATUS AND VEHICLE

(71) Applicant: SUBARU CORPORATION, Tokyo (JP)

(72) Inventors: Keigo YAMADA, Tokyo (JP); Yoshinobu YAMAZAKI, Tokyo (JP); Hiroomi KOBAYASHI, Tokyo (JP); Akihiro NABESHIMA, Tokyo (JP); Takeshi YONEDA, Tokyo (JP); Fumiya SATO, Tokyo (JP)

(73) Assignee: SUBARU CORPORATION, Tokyo (JP)

(21) Appl. No.: 19/275,183

(22) Filed: Jul. 21, 2025

(30) Foreign Application Priority Data
Aug. 29, 2024 (JP) 2024-147798

(51) Int. Cl. B60L 3/10

(52) U.S. Cl. CPC B60L 3/10; B60L 2240/423; B60L 2250/10

(57) ABSTRACT

A slip determination apparatus to be applied to a vehicle includes electric motor control circuitry and determination circuitry. The electric motor control circuitry is configured to generate a first torque command value that fluctuates at a predetermined frequency, and determine torque of an electric motor, based on the first torque command value and a second torque command value that depends on a driving operation performed by a driver who drives the vehicle. The determination circuitry is configured to detect a fluctuation component at the predetermined frequency in a number of revolutions of the electric motor, and determine whether the vehicle is slipping, based on the fluctuation component.

### CROSS-REFERENCE TO RELATED APPLICATIONS

The present application claims priority from Japanese Patent Application No. 2024-147798 filed on Aug. 29, 2024, the entire contents of which are hereby incorporated by reference.

### BACKGROUND

The disclosure relates to a slip determination apparatus that determines the occurrence of a slip of a vehicle and to a vehicle including such a slip determination apparatus.

A vehicle such as an automobile can cause a slip depending on road conditions or other factors. Japanese Unexamined Patent Application Publication (JP-A) No. 2022-039447, for example, discloses a technique that corrects a motor revolution speed when a resonant frequency of a vibration generated in a drive system is a predetermined resonant frequency indicating that the vehicle is slipping.

### SUMMARY

An aspect of the disclosure provides a slip determination apparatus to be applied to a vehicle. The slip determination apparatus includes electric motor control circuitry and determination circuitry. The electric motor control circuitry is configured to generate a first torque command value that fluctuates at a predetermined frequency, and determine torque of an electric motor, based on the first torque command value and a second torque command value that depends on a driving operation performed by a driver who drives the vehicle. The determination circuitry configured to detect a fluctuation component at the predetermined frequency in a number of revolutions of the electric motor, and determine whether the vehicle is slipping, based on the fluctuation component.

An aspect of the disclosure provides a vehicle including an electric motor, electric motor control circuitry, and determination circuitry. The electric motor is configured to generate a driving force to be used for travel of the vehicle. The electric motor control circuitry is configured to generate a first torque command value that fluctuates at a predetermined frequency, and determine torque of the electric motor, based on the first torque command value and a second torque command value that depends on a driving operation performed by a driver who drives the vehicle. The determination circuitry is configured to detect a fluctuation component at the predetermined frequency in a number of revolutions of the electric motor, and determine whether the vehicle is slipping, based on the fluctuation component.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary configuration of a vehicle according to one example embodiment of the disclosure.

FIG. 2 is a characteristic diagram illustrating an exemplary sensitivity characteristic indicating an effect of torque of a motor illustrated in FIG. 1 on a revolution speed of the motor.

FIG. 3 is a timing chart illustrating an exemplary operation of the vehicle illustrated in FIG. 1.

### DETAILED DESCRIPTION

There is a demand for a vehicle capable of determining whether the vehicle is slipping, and it is expected to provide an apparatus that makes it possible to effectively determine whether a vehicle is slipping.

It is desirable to provide a slip determination apparatus making it possible to effectively determine whether a vehicle is slipping and a vehicle including such a slip determination apparatus.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

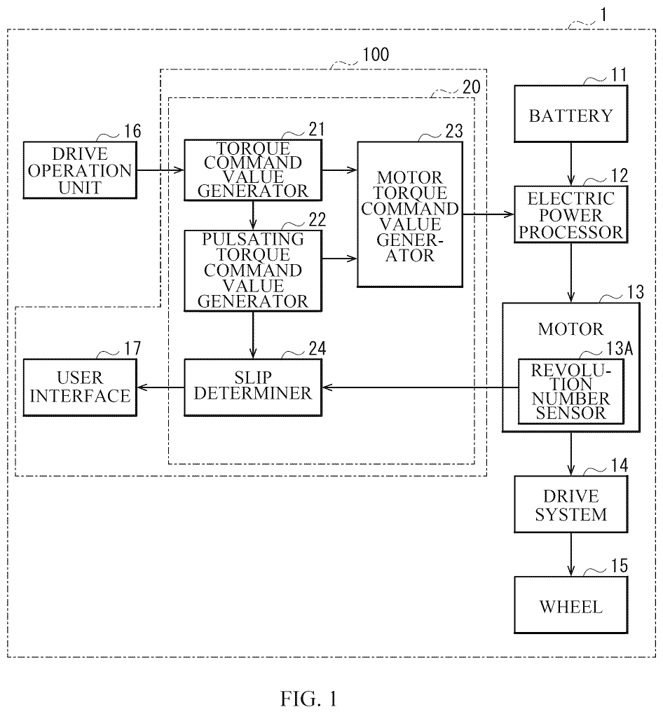

FIG. 1 illustrates an exemplary configuration of a vehicle 1 according to an example embodiment. The vehicle 1 may be an electric vehicle including a battery 11, an electric power processor 12, a motor 13, a drive system 14, a wheel 15, a drive operation unit 16, a user interface 17, and a control circuit 20. The user interface 17 and the control circuit 20 may constitute a slip determination apparatus 100.

The battery 11 may be configured to hold electric power and supply direct-current (DC) power to the electric power processor 12. The battery 11 may be further configured to hold electric power supplied from the electric power processor 12.

The electric power processor 12 may be configured to control the electric power to be supplied to the motor 13. In some embodiments, the electric power processor 12 may include an inverter that converts the DC power supplied from the battery 11 into alternating-current (AC) power, based on a motor torque command value supplied from the control circuit 20, and supply the AC power to the motor 13. The electric power processor 12 may be further configured to supply the electric power supplied from the motor 13 to the battery 11.

The motor 13 may be configured to generate a driving force, which is mechanical energy, based on the AC power supplied from the electric power processor 12. The motor 13 may transmit the driving force to the wheel 15 via the drive system 14. This allows the vehicle 1 to travel based on the driving force. The motor 13 may also serve as a power generator that generates electric power, based on the mechanical energy supplied from the drive system 14, and may be configured to supply generated AC power to the electric power processor 12.

The motor 13 may include a revolution number sensor 13A. The revolution number sensor 13A may detect the number of revolutions of the motor 13. The revolution number sensor 13A may supply detection data on the number of revolutions of the motor 13 to the control circuit 20.

The drive system 14 may transmit the driving force supplied from the motor 13 to the wheel 15. The drive system 14 may include a speed reduction mechanism, a differential gear, and various kinds of shafts including a drive shaft that are provided in a transmission path from the motor 13 to the wheel 15.

The wheel 15 may be a driving wheel of the vehicle 1. The wheel 15 may rotate around an axle, based on the driving force supplied from the drive system 14, causing the vehicle 1 to travel on a road surface.

The drive operation unit 16 may include a steering wheel, an accelerator pedal, a brake pedal, and various kinds of levers to be operated by a driver who drives the vehicle 1.

In some embodiments, the control circuit 20 may be an electronic control unit (ECU) and include one or more processors and one or memories. The control circuit 20 may be operatable as a torque-command-value generator 21, a pulsating-torque-command-value generator 22, a motor-torque-command-value generator 23, or a slip determiner 24 by executing software.

The torque-command-value generator 21 may be configured to generate a torque command value indicating a command value of torque of the motor 13, based on an operation on the accelerator pedal in the drive operation unit 16 performed by the driver. The torque-command-value generator 21 may be configured to supply data on the generated torque command value to the pulsating-torque-command-value generator 22.

The pulsating-torque-command-value generator 22 may be configured to generate a pulsating torque command value that fluctuates at a predetermined frequency f0. The pulsating-torque-command-value generator 22 may generate the pulsating torque command value having an amplitude that depends on the torque command value generated by the torque-command-value generator 21. In some embodiments, the pulsating-torque-command-value generator 22 may generate the pulsating torque command value and cause the amplitude of the pulsating torque command value to be about 10% of the torque command value upon the fluctuation. The pulsating-torque-command-value generator 22 may be configured to supply data on the amplitude of the generated pulsating torque command value to the slip determiner 24.

The motor-torque-command-value generator 23 may be configured to generate a motor torque command value indicating a command value of torque of the motor 13, based on the torque command value generated by the torque-command-value generator 21 and the pulsating torque command value generated by the pulsating-torque-command-value generator 22. In some embodiments, the motor-torque-command-value generator 23 may generate the motor torque command value by adding the torque command value generated by the torque-command-value generator 21 to the pulsating torque command value generated by the pulsating-torque-command-value generator 22.

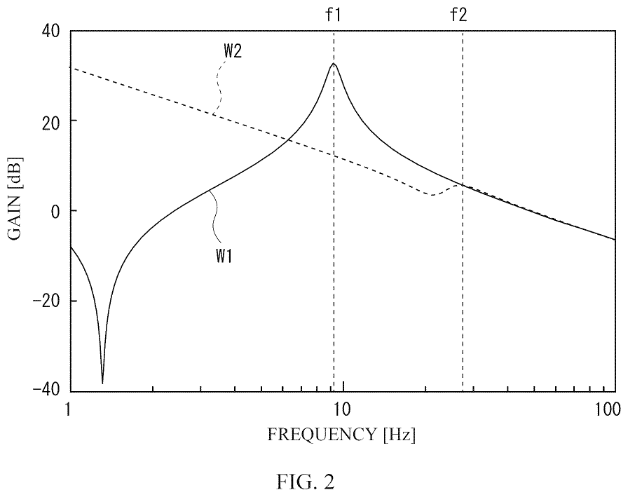

The slip determiner 24 may detect a fluctuation component at the frequency f0 in the number of revolutions of the motor 13, based on a result of detection by the revolution number sensor 13A, and determine whether the vehicle 1 is slipping, based on the fluctuation component. That is, since the pulsating torque command value fluctuates at the frequency f0, the number of revolutions of the motor 13 may include the fluctuation component at the frequency f0. The fluctuation component may vary in magnitude depending on the slipping state of the vehicle 1. FIG. 2 is a diagram illustrating an exemplary sensitivity characteristic of the vehicle 1 indicating an effect of the torque of the motor 13 on the number of revolutions of the motor 13, where a horizontal axis represents a frequency, and a vertical axis represents a gain. In FIG. 2, a characteristic W1 indicated by a solid line represents a sensitivity characteristic in a state where the vehicle 1 is not slipping, and a characteristic W2 indicated by a broken line represents a sensitivity characteristic in a state where a friction coefficient between the wheel 15 and the road surface is zero and where the vehicle 1 is completely slipping.

In the state where the vehicle 1 is not slipping (characteristic W1), resonance may be produced at a frequency f1. Since the drive shaft in the drive system 14 may include mechanical components such as a spring component or a damper component, torsional resonance may be produced in a rotational direction of the drive shaft. In the state where the vehicle 1 is not slipping, the vehicle 1 may be caused to travel by rotating the wheel 15, which imposes a large mechanical load on the drive system 14. Accordingly, as illustrated in FIG. 2, a torsional natural frequency may be a frequency f1 which is a low frequency of about 9 Hz, for example.

When the vehicle 1 slips, the torsional natural frequency may gradually increase from the frequency f1 in accordance with the degree of the slip. That is, the mechanical load on the drive system 14 may gradually decreases as the degree of the slip of the vehicle 1 increases, and the torsional natural frequency may gradually increase accordingly. In the state where the vehicle 1 is completely slipping (characteristic W2), the torsional natural frequency may be a frequency f2 which is a high frequency of about 28 Hz, for example.

In a frequency range higher than the frequency f1 and lower than the frequency f2, the gain of the sensitivity characteristic may vary depending on the slip state of the vehicle 1. That is, the gain may increase as the degree of the slip decreases, and may decrease as the degree of the slip increases.

For the vehicle 1, the frequency f0 at which the pulsating torque command value fluctuates may be set as a frequency within the frequency range. Since the pulsating torque command value fluctuates at the frequency f0, the number of revolutions of the motor 13 may include the fluctuation component at the frequency f0. Since the sensitivity characteristic varies depending on the slip state of the vehicle 1 as illustrated in FIG. 2, the fluctuation component in the number of revolutions of the motor 13 may vary in magnitude depending on the slip state of the vehicle 1. Accordingly, the slip determiner 24 may be configured to determine whether the vehicle 1 is slipping, based on the magnitude of the fluctuation component at the frequency f0.

In some embodiments, the slip determiner 24 may generate a threshold value, based on the data on the amplitude of the pulsating torque command value supplied from the pulsating-torque-command-value generator 22, as described below. Thereafter, the slip determiner 24 may determine whether the vehicle 1 is slipping by comparing the amplitude of the fluctuation component at the frequency f0 in the number of revolutions of the motor 13 with the threshold value.

The user interface 17 may include a display such as a liquid crystal display, various kinds of indicator, and a speaker. The user interface 17 may be configured to provide information to the driver by displaying images or outputting sounds. The user interface 17 may be configured to notify the driver of the result of determination by the slip determiner 24.

In one embodiment, the torque-command-value generator 21, the pulsating-torque-command-value generator 22, and the motor-torque-command-value generator 23 in the control circuit 20 may each serve as “electric motor control circuitry”. In one embodiment, the pulsating torque command value may serve as a “first torque command value”. In one embodiment, the torque command value may serve as a “second torque command value”. In one embodiment, the slip determiner 24 in the control circuit 20 may serve as “determination circuitry”. In one embodiment, the user interface 17 may serve as a “user interface”. In one embodiment, the motor 13 may serve as an “electric motor”. In one embodiment, the drive system 14 may serve as a “drive system”. In one embodiment, the wheel 15 may serve as a “wheel”. In one embodiment, the frequency f1 may serve as a “first frequency”. In one embodiment, the frequency f2 may serve as a “second frequency”.

Next, a description will be given of operations and effects of the vehicle 1 according to the present example embodiment.

First, an exemplary operation of the vehicle 1 is described with reference to FIG. 1. The battery 11 may hold electric power and supply DC power to the electric power processor 12. The electric power processor 12 may control the electric power to be supplied to the motor 13. The motor 13 may generate a driving force, which is mechanical energy, based on AC power supplied from the electric power processor 12. The revolution number sensor 13A in the motor 13 may detect the number of revolutions of the motor 13. The motor 13 may also serve as a power generator that generates electric power, based on the mechanical energy supplied from the drive system 14, and supply the generated AC power to the electric power processor 12. In this case, the electric power processor 12 may supply the electric power supplied from the motor 13 to the battery 11, and the battery 11 may hold the electric power supplied from the electric power processor 12. The drive system 14 may transmit the driving force supplied from the motor 13 to the wheel 15. The wheel 15 may cause the vehicle 1 to travel on the road surface by rotating around the axle, based on the driving force supplied from the drive system 14.

The torque-command-value generator 21 in the control circuit 20 may generate a torque command value indicating a command value of torque of the motor 13, based on an operation on the accelerator pedal in the drive operation unit 16 performed by the driver. The pulsating-torque-command-value generator 22 may generate a pulsating torque command value that fluctuates at the predetermined frequency f0. The motor-torque-command-value generator 23 may generate the motor torque command value indicating a command value of the torque of the motor 13, based on the torque command value generated by the torque-command-value generator 21, and the pulsating torque command value generated by the pulsating-torque-command-value generator 22. The slip determiner 24 may detect the fluctuation component at the frequency f0 in the number of revolutions of the motor 13, based on the result of detection by the revolution number sensor 13A, and determine whether the vehicle 1 is slipping, based on the fluctuation component. The user interface 17 may notify the driver of the result of determination by the slip determiner 24.

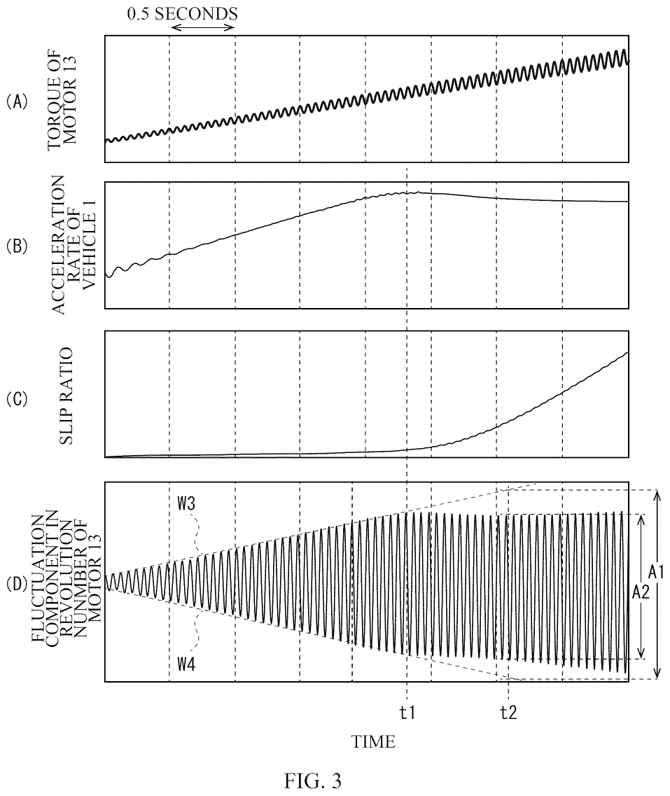

FIG. 3 illustrates an exemplary operation of the vehicle 1, where Part (A) illustrates the torque of the motor 13, Part (B) illustrates an acceleration rate of the vehicle 1, Part (C) illustrates a slip ratio, and Part (D) illustrates the fluctuation component at the frequency f0 in the number of revolutions of the motor 13. Each of the parts of FIG. 3 has a horizontal axis representing time with a scale of 0.5 seconds.

In this example, the driver may accelerate the vehicle 1 by depressing the accelerator pedal. The torque-command-value generator 21 may gradually increase the torque command value, based on the operation on the accelerator pedal performed by the driver. The pulsating-torque-command-value generator 22 may generate the pulsating torque command value having an amplitude of about 10% of the torque command value and fluctuating at the frequency f0. The motor-torque-command-value generator 23 may generate the motor torque command value by adding the torque command value generated by the torque-command-value generator 21 to the pulsating torque command value generated by the pulsating-torque-command-value generator 22. The electric power processor 12 may convert the DC power supplied from the battery 11 into AC power, based on the motor torque command value, and supply the AC power to the motor 13. The motor 13 may generate a driving force, which is mechanical energy, based on the AC power. As illustrated in Part (A) of FIG. 3, the torque of the motor 13 may increase while fluctuating at the frequency f0 as time proceeds. In association with this, the acceleration rate of the vehicle 1 may increase as illustrated in Part (B) of FIG. 3.

The revolution number sensor 13A in the motor 13 may detect the number of revolutions of the motor 13. The slip determiner 24 may perform processing such as bandpass filter processing on time-series data on the number of revolutions of the motor 13, to thereby extract the fluctuation component at the frequency f0. As illustrated in Part (C) of FIG. 3, in a period of time prior to a timing t1, the slip rate may be sufficiently low, and the vehicle 1 is not slipping. In the state where the vehicle 1 is not slipping, the amplitude of the fluctuation component may gradually increase, as indicated by broken lines W3 and W4 in Part (D) of FIG. 3. That is, the amplitude of the fluctuation component may gradually increases as the pulsating torque command value gradually increases.

Thereafter, as illustrated in Part (C) of FIG. 3, in a period of time after the timing t1, the slip ratio may start increasing. In other words, the vehicle 1 may start slipping. Accordingly, as illustrated in Part (B) of FIG. 3, the acceleration rate of the vehicle 1 may stop increasing. The amplitude of the fluctuation component in the number of revolutions of the motor 13 may become smaller than the amplitude indicated by the broken lines W3 and W4. At a timing t2, for example, an amplitude A2 of the fluctuation component may be smaller than an amplitude A1 in the state where the vehicle 1 is not slipping. That is, the gain decreases as the degree of slip increases as illustrated in FIG. 2, the amplitude of the fluctuation component may become smaller, accordingly. The slip determiner 24 may determine whether the vehicle 1 is slipping, based on the amplitude of the fluctuation component.

In some embodiments, the slip determiner 24 may estimate the amplitude of the fluctuation component in the number of revolutions of the motor 13 in the state where the vehicle 1 is not slipping, based on the data on the amplitude of the pulsating torque command value supplied from the pulsating-torque-command-value generator 22. Thereafter, the slip determiner 24 may generate a threshold value, based on the estimated amplitude. At the timing t2, for example, the slip determiner 24 may estimate the amplitude A1. Thereafter, the slip determiner 24 may set a value slightly less than the amplitude A1 as the threshold value.

The slip determiner 24 may calculate the amplitude of the fluctuation component by obtaining a difference between a maximum value and a minimum value of the fluctuation component extracted in the bandpass filter processing as illustrated in Part (D) of FIG. 3. Thereafter, the slip determiner 24 may compare the amplitude of the fluctuation component with the threshold value, to thereby determine whether the vehicle 1 is slipping. If the amplitude of the fluctuation component is greater than the threshold value, the slip determiner 24 may determine that the vehicle 1 is not slipping. If the amplitude of the fluctuation component is less than the threshold value, the slip determiner 24 may determine that the vehicle 1 is slipping.

The user interface 17 may notify the driver of the result of determination by the slip determiner 24. In some embodiments, the user interface 17 may turn on the indicator or output a predetermined sound when the vehicle 1 is slipping. Issuing the notification indicating that the vehicle 1 is slipping may urge the driver to decrease the amount of depression of the accelerator pedal. This helps to prevent the vehicle 1 from slipping and achieves safety traveling.

As described above, the slip determination apparatus 100 includes the electric motor control circuitry (the torque-command-value generator 21, the pulsating-torque-command-value generator 22, and the motor-torque-command-value generator 23), and the determination circuitry (the slip determiner 24). The electric motor control circuitry is configured to generate a first torque command value (the pulsating torque command value) that fluctuates at the predetermined frequency f0, and determine torque of the electric motor (the motor 13), based on the first torque command value (the pulsating torque command value) and a second torque command value (the torque command value) that depends on a driving operation performed by the driver who drives the vehicle 1. The determination circuitry is configured to detect a fluctuation component at the predetermined frequency f0 in the number of revolutions of the electric motor (the motor 13), and determine whether the vehicle 1 is slipping, based on the fluctuation component. It is therefore possible for the slip determination apparatus 100 to effectively determine whether the vehicle 1 is slipping.

According to the technique disclosed in JP-A No. 2022-039447, for example, whether the vehicle 1 is slipping is determined based on a variation of resonant frequency. The technique may possibly take a certain period of time to accurately detect the variation of frequency. In contrast, according to the present example embodiment, the slip determination apparatus 100 determines whether the vehicle 1 is slipping, based on the fluctuation component at the frequency f. This allows a variation in the magnitude of the fluctuation component to be detected in a short time. It is therefore possible for the slip determination apparatus 100 to effectively determine whether the vehicle 1 is slipping.

Further, the determination circuitry (the slip determiner 24) in the slip determination apparatus 100 may be configured to, when the magnitude of the fluctuation component is less than the threshold value, determine that the vehicle 1 is slipping. This allows the slip determination apparatus 100 to determine whether the vehicle 1 is slipping by simply comparing the magnitude of the fluctuation component with the threshold value. It is therefore possible for the slip determination apparatus 100 to effectively determine whether the vehicle 1 is slipping.

Further, the electric motor control circuitry (the torque-command-value generator 21, the pulsating-torque-command-value generator 22, and the motor-torque-command-value generator 23) in the slip determination apparatus 100 may be configured to generate the first torque command value and cause the first torque command value (the pulsating torque command value) that fluctuates at the frequency f0 to have an amplitude that depends on the second torque command value (the torque command value). The determination circuitry (the slip determiner 24) in the slip determination apparatus 100 may be configured to generate the threshold value, based on the amplitude of the first torque command value (the pulsating torque command value). This allows the vehicle 1 to decrease the amplitude of the pulsating torque command value when the acceleration rate is low, and increase the amplitude of the pulsating torque command value when the acceleration rate is high. In this way, it is possible to set the amplitude of the pulsating torque command value to an appropriate value. Further, even when the amplitude of the pulsating torque command value is changed as described above, it is possible for the vehicle 1 to set the threshold value to an appropriate value. It is therefore possible for the vehicle 1 to effectively determine whether the vehicle 1 is slipping.

Further, according to the slip determination apparatus 100, the predetermined frequency f0 may be a frequency higher than the first frequency (the frequency f1) and lower than the second frequency (the frequency f2). The first frequency (the frequency f1) may be a torsional natural frequency, in the state where the vehicle 1 is not slipping, of the drive system 14 configured to transmit a driving force of the electric motor (the motor 13) to the wheel 15. The second frequency (the frequency f2) may be a torsional natural frequency of the drive system 14 in the state where the friction coefficient between the wheel 15 of the vehicle 1 and the road surface is zero. As illustrated in FIG. 2, the gain of the sensitivity characteristic may vary depending on the slip state of the vehicle 1 in the frequency range from the frequency f1 to the frequency f2. For example, at a frequency higher than the frequency f2, the gain may not vary depending on the slip state of the vehicle 1. Further, a frequency lower than the frequency f1 may be used for the travel of the vehicle 1 and may be a frequency at which a human is likely to feel a vibration. Accordingly, the slip determination apparatus 100 may set the frequency f0 of the pulsating torque command value to a frequency higher than the frequency f1 and lower than the frequency f2. This allows the gain of the sensitivity characteristic to vary depending on the slip state of the vehicle 1, enabling the determination as to whether the vehicle 1 is slipping. Further, the slip determination apparatus 100 makes it possible to prevent a torque variation of the motor 13 that depends on the pulsating torque command value from having an effect on a behavior of the vehicle 1, making the driver less likely to feel the torque variation. It is therefore possible for the vehicle 1 to effectively determine whether the vehicle 1 is slipping.

The slip determination apparatus 100 may further include the user interface 17 that issues a notification to the driver when the determination circuitry (the slip determiner 24) determines that the vehicle 1 is slipping. This allows the driver to surely recognize whether the vehicle 1 is slipping. In general, the driver recognizes the traveling state of the vehicle by sensing a behavior such as a vibration of the vehicle. It is therefore more difficult for the driver to recognize whether the vehicle is slipping in a case where the vehicle is an electric vehicle than in a case where the vehicle is an engine-driven vehicle. To address such a concern, the user interface 17 in the vehicle 1 may issue a notification to the driver when the vehicle 1 is determined to be slipping. This allows the driver to more surely recognize whether the vehicle 1 is slipping and decrease the amount of depression of the accelerator pedal, for example. It is therefore possible for the vehicle 1 to achieve safety traveling.

According to the foregoing example embodiments described above, the electric motor control circuitry and the determination circuitry are provided. The motor generation control circuitry is configured to generate the first torque command value that fluctuates at a predetermined frequency, and determine the torque of the electric motor, based on the first torque command value and the second torque command value that depends on a driving operation performed by the driver who drives the vehicle. The determination circuitry is configured to detect the fluctuation component at the predetermined frequency in the number of revolutions of the electric motor, and determine whether the vehicle is slipping, based on the fluctuation component. It is therefore possible to effectively determine whether the vehicle is slipping.

According to the foregoing example embodiments, the determination circuitry may be configured to determine that the vehicle 1 is slipping when the magnitude of the fluctuation component is less than the threshold value. It is therefore possible to effectively determine whether the vehicle is slipping.

According to the foregoing example embodiments, the electric motor control circuitry may be configured to generate the first torque command value and cause the first torque command value that fluctuates at the predetermined frequency to have an amplitude that depends on the second torque command value. The determination circuitry may be configured to generate the threshold value, based on the amplitude of the first torque command value. It is therefore possible to effectively determine whether the vehicle is slipping.

According to the foregoing example embodiments, the predetermined frequency may be a frequency higher than the first frequency and lower than the second frequency. The first frequency may be a torsional natural frequency, in the state where the vehicle is not slipping, of the drive system configured to transmit the driving force of the electric motor to the wheel 15. The second frequency may be a torsional natural frequency of the drive system in the state where the friction coefficient between the wheel 15 of the vehicle 1 and the road surface is zero. It is therefore possible to effectively determine whether the vehicle is slipping.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, in the foregoing example embodiments, the user interface 17 may turn on the indicator or output a predetermined sound when the vehicle 1 is determined to be slipping; however, this is non-limiting. In some embodiments, various methods of notifying the driver of the occurrence of a slip of the vehicle 1 may be employed.

Note that the effects described herein are mere examples and non-limiting, and other effects may be provided.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The terms “substantially”, “approximately”, “about”, and their variants having similar meanings thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

Further, the disclosure may include the following aspects.
(1) A slip determination apparatus to be applied to a vehicle, the slip determination apparatus including:
   electric motor control circuitry configured to
      generate a first torque command value that fluctuates at a predetermined frequency, and
      determine torque of an electric motor, based on the first torque command value and a second torque command value that depends on a driving operation performed by a driver who drives the vehicle; and
   determination circuitry configured to
      detect a fluctuation component at the predetermined frequency in a number of revolutions of the electric motor, and
      determine whether the vehicle is slipping, based on the fluctuation component.
(2) The slip determination apparatus according to (1), in which the determination circuitry is configured to, when a magnitude of the fluctuation component is less than a threshold value, determine that the vehicle is slipping.
(3) The slip determination apparatus according to (2), in which
   the electric motor control circuitry is configured to generate the first torque command value and cause the first torque command value that fluctuates at the predetermined frequency to have an amplitude that depends on the second torque command value, and
   the determination circuitry is configured to generate the threshold value, based on the amplitude of the first torque command value.
(4) The slip determination apparatus according to any one of (1) to (3), in which
   the predetermined frequency is a frequency higher than a first frequency and lower than a second frequency,
   the first frequency is a torsional natural frequency of a drive system in a state where the vehicle is not slipping, the drive system being configured to transmit a driving force of the electric motor to a wheel of the vehicle, and
   the second frequency is a torsional natural frequency of the drive system in a state where a friction coefficient between the wheel of the vehicle and a road surface is zero.
(5) The slip determination apparatus according to any one of (1) to (4), further including a user interface configured to issue a notification to the driver when the determination circuitry determines that the vehicle is slipping.
(6) A vehicle including:
   an electric motor configured to generate a driving force to be used for travel of the vehicle;
   electric motor control circuitry configured to
      generate a first torque command value that fluctuates at a predetermined frequency, and
      determine torque of the electric motor, based on the first torque command value and a second torque command value that depends on a driving operation performed by a driver who drives the vehicle; and
   determination circuitry configured to
      detect a fluctuation component at the predetermined frequency in a number of revolutions of the electric motor, and
      determine whether the vehicle is slipping, based on the fluctuation component.

According to the foregoing example embodiments, it is possible for the slip determination apparatus to effectively determine whether the vehicle is slipping.

1. A slip determination apparatus to be applied to a vehicle, the slip determination apparatus comprising:
electric motor control circuitry configured to
generate a first torque command value that fluctuates at a predetermined frequency, and
determine torque of an electric motor, based on the first torque command value and a second torque command value that depends on a driving operation performed by a driver who drives the vehicle; and
determination circuitry configured to
detect a fluctuation component at the predetermined frequency in a number of revolutions of the electric motor, and
determine whether the vehicle is slipping, based on the fluctuation component.

2. The slip determination apparatus according to claim 1, wherein the determination circuitry is configured to, when a magnitude of the fluctuation component is less than a threshold value, determine that the vehicle is slipping.

3. The slip determination apparatus according to claim 2, wherein
the electric motor control circuitry is configured to generate the first torque command value and cause the first torque command value that fluctuates at the predetermined frequency to have an amplitude that depends on the second torque command value, and
the determination circuitry is configured to generate the threshold value that depends on the amplitude of the first torque command value.

4. The slip determination apparatus according to claim 1, wherein
the predetermined frequency comprises a frequency higher than a first frequency and lower than a second frequency,
the first frequency comprises a torsional natural frequency of a drive system in a state where the vehicle is not slipping, the drive system being configured to transmit a driving force of the electric motor to a wheel of the vehicle, and
the second frequency comprises a torsional natural frequency of the drive system in a state where a friction coefficient between the wheel of the vehicle and a road surface is zero.

5. The slip determination apparatus according to claim 1, further comprising a user interface configured to issue a notification to the driver when the determination circuitry determines that the vehicle is slipping.

6. A vehicle comprising:
an electric motor configured to generate a driving force to be used for travel of the vehicle;
electric motor control circuitry configured to
generate a first torque command value that fluctuates at a predetermined frequency, and
determine torque of the electric motor, based on the first torque command value and a second torque command value that depends on a driving operation performed by a driver who drives the vehicle; and
determination circuitry configured to
detect a fluctuation component at the predetermined frequency in a number of revolutions of the electric motor, and
determine whether the vehicle is slipping, based on the fluctuation component.
